(19) United States
(12) Patent Application Publication
(10) Pub. No.: US 2026/0364489 A1
(43) Pub. Date: Nov. 19, 2026

(54) METHOD FOR RECOVERING AND UPGRADING LOW CONCENTRATION SURFACTANTS FROM WASH WATER

(71) Applicant: CiDRA Corporate Services LLC, Wallingford, CT (US)

(72) Inventors: Mark FERNALD, Hilton Head Island, SC (US); Michael Stephen RYAN, Newtown, CT (US); Christian O'KEEFE, Durham, CT (US); Timothy J. BAILEY, Longmeadow, MA (US)

(21) Appl. No.: 19/153,730

(22) PCT Filed: Feb. 28, 2024
(86) PCT No.: PCT/US2024/017608

§ 371 Date: Aug. 5, 2025

Related U.S. Application Data
(60) Provisional application No. 63/448,727, filed on Feb. 28, 2023.

(51) Int. Cl. B01D 17/02; B01D 1/00

(52) U.S. Cl. CPC B01D 17/0217; B01D 1/00; B01D 2257/70

(57) ABSTRACT

A process of separating a surfactant in a liquid containing the surfactant and a solvent, includes:
adding a salt to the liquid solution for providing a denser liquid and forcing soluble surfactant out of solution; and
increasing a mechanical g-force applied to the denser liquid to separate the surfactant in the liquid solution.

The process also includes providing the mechanical g-force via centrifugation, e.g., including by a centrifuge. The mechanical g-force may be about 690 g applied to the denser liquid, e.g. for 30 to 60 seconds. The salt may be sodium chloride. The process may also include elevating the temperature of the denser liquid before the increasing the mechanical g-force.

### CROSS-REFERENCE TO RELATED PATENT APPLICATIONS

The present application claims the benefit of U.S. Provisional Patent Application No. 63/448,727, filed 28 Feb. 2023, which is incorporated by reference herein in its entirety.

### BACKGROUND OF THE INVENTION

### 1. Technical Field

This invention relates generally to a technique for recovering surfactant from wash water in a mineral recovery process.

### 2. Description of Related Art

Surfactants are used in many processes to clean and remove unwanted contaminants. In many of these processes the surfactant is eventually lost due to dilution from the rinse water which lowers the concentration to a level where the solution becomes ineffective and is therefore discarded. Discarded rinse water containing low concentrations of surfactant can lead to increased operating expenses as well as have negative impact on the environment.

### Known Techniques for Recovering Surfactant From Wash Water in a Mineral Recovery Process

Several methods are known in the art to recover and upgrade low concentration surfactant from rinse water, as follows:

### Evaporation

Evaporation can be used whereby the low concentration solution is evaporated at an elevated temperature leaving behind the surfactant which does not undergo evaporation at the selected temperature. Upgrading to a usable concentration can be controlled by terminating the evaporation of the water at the desired concentration. Drawbacks of this approach include the time it takes to reach upgraded concentrations as well as the energy costs to heat the fluid.

### Membrane Separation

Membrane separation has also demonstrated the ability to separate and upgrade low concentrations of surfactants. This method relies on a membrane which allows permeation of the water but retains the surfactant. Recirculation and/or multiple filters are used to upgrade the concentration to the desired level. Drawbacks of this technology are the sensitivity the membranes have to water quality. Proper operation is attained when the water quality meets the requirements for the membrane filter. Typical water properties required by the membrane filter are low total dissolved solids, low chlorine, low percent solids, to name a few. Cleaning cycles are commonly required with membrane filtering due to build up on the surface on the membrane. Prefiltering is usually required to remove particulates that may damage the membrane. Operating outside these parameters can lead to a reduction in filter lifetime and/or lower filtration rates over time.

### Foam Fractionation

Foam fractionation is a process whereby a surfactant can be separated and upgraded from low concentration solutions. This is accomplished by aerating the fluid which results in the hydrophobic tail of the surfactant to attach to the bubble surface as it rises. The bubbles coalesce at the top of the fluid forming a foam which leads to a higher concentration of surfactant due to water draining from the surface of the bubbles. The foam is typically swept away and collected separately where it is allowed to collapse. The liquid from the collapsed foam typically goes through multiple stages of aeration and foaming to attain the desirable upgrade. Drawbacks of this approach are long residence times and multiple stages to attain the desired results.

### Centrifuge

Centrifugal separation of surfactants is possible provided the surfactant is not soluble and the density difference between the carry fluid (typically water) and the surfactant is large enough to allow separation in a timely and cost-effective manner.

This separation method limits the selection of possible surfactants to insoluble surfactants with significant density differences compared to water.

### Need for an Improved Technique for Recovering Surfactant

In view of the aforementioned, there is a need in the art for a better way for recovery, upgrading and reuse of surfactants normally lost in a rinse stream.

### SUMMARY OF THE DISCLOSURE

### The Present Invention

The present invention provides a new and improved technique for the separation of low concentration surfactants (solute) from a solvent (typically water). By way of example, the novel separation process involves using a combination of a centrifuge, a thermal heater and a chemical salt. In particular, this novel separation process circumvents the drawbacks of the aforementioned previous methods known in the art through the addition of a chemical salt. For example, a chemical salt, which is added to the low concentration surfactant solution, has two main purposes. First, the addition of the chemical salt increases the density of the liquid which in turn increases the density difference between the surfactant and the liquid. Typical surfactants have densities close to that of water, e.g., approximately 1 gram/milliliter (gr/ml). Second, the addition of the chemical salt lowers the cloud point temperature of the surfactant solution which promotes micelle formation. This occurs because the water can no longer solubilize both the disassociated salt and surfactant resulting in the precipitation of the least soluble solute which is the surfactant. Precipitation of the surfactant promotes aggregation of the micelles. These large aggregates, which have lower density than the surrounding salt solution, can be readily separated when placed in a high g environment (aka a high “gravity” environment) such as a centrifuge. The surfactant coalesces as a lighter (i.e., less dense) liquid, e.g. where a high percentage can be recovered at a higher concentration than in the original solution. In addition, raising the temperature of the solution prior to applying the higher g-force will assist in separation.

In effect, the present invention provides a new and unique method for separating and recovering low concentration water soluble surfactants through the addition of a salt coupled with using an elevated g-force.

### Specific Embodiments

### The Process

By way of example, the present invention may take the form of a process of separating a surfactant in a liquid solution containing the surfactant and a solvent, featuring steps of:
adding a salt to the liquid solution for providing a denser liquid and forcing soluble surfactant out of solution; and
increasing a mechanical g-force applied to the denser liquid to separate the surfactant in the liquid solution.

In effect, the addition of the salt forces the soluble surfactant out of solution, e.g., because the salt changes the density of the liquid solution so that surfactants easily come out of solution. The density of the solution lowers with the introduction of the salt enabling the surfactant to come out of the liquid solution and be easily separated.

The process may include one or more of the following features:

The process may include providing the mechanical g-force via centrifugation, e.g., including by using a centrifuge.

The mechanical g-force may be about 690 g applied to the denser liquid, e.g. for to 60 seconds.

The salt may be sodium chloride (NaCl).

The process may also include elevating the temperature of the denser liquid before the increasing the mechanical g-force.

The solvent may be water, and the denser liquid may include a density of about 1.05 grams per milliliter (g/ml) or higher.

The denser liquid may be contained in one or more tubes for centrifugation; and the process further may include extracting the surfactant from a top portion of the denser liquid in the one or more tubes after the centrifugation.

The surfactant may be a nonionic surfactant, e.g., including where the nonionic surfactant is an ethoxylated alcohol-based surfactant.

The salt may be a chemical salt.

The temperature may be elevated to a range of 45.5 to 60 degrees Celsius (C).

The process may further include reducing density of the liquid solution or the denser liquid through evaporation.

The density reducing may be carried out by heating the liquid solution or the denser liquid to about 70 degrees C.

The process may also include one or more of other features set forth herein.

### Apparatus

The present invention may also take the form of apparatus for implementing the process, as follows:

The apparatus may include, or take the form of, a separation processor, for separating a surfactant from a solvent in a solution, featuring a fluid spinning device and a controller.

The fluid spinning device may be configured to:
receive one or more tubes, each tube having a top portion and a bottom portion and containing a solution having a solvent and a surfactant, and also having a salt added to the solution,
receive a control signal containing information to spin the fluid spinning device for a predetermined period of time and apply a high g environment that causes a more dense solvent to move downwardly towards the bottom portion of the one or more tubes and a less dense surfactant to move upwardly towards the top portion of the one or more tubes to separate the more dense solvent from the less dense surfactant, and
provide one or more processed tubes, each processed tube having the more dense solvent in the bottom portion and the less dense surfactant in the top portion.

The controller may be configured to provide the signal to spin the fluid spinning device and apply the high g environment to separate the more dense solvent from the less dense surfactant.

The apparatus may also include one or more of the features set forth herein.

### BRIEF DESCRIPTION OF THE DRAWING

Referring now to the drawing, which is not necessarily drawn to scale, the foregoing and other features and advantages of the present invention will be more fully understood from the following detailed description of illustrative embodiments, taken in conjunction with the accompanying drawing in which like elements are numbered alike:

FIG. 1 shows examples of a percent surfactant recovery and of low concentration surfactant solutions with and without the addition of salt at various spin times and temperatures.

FIG. 2 shows a surfactant upgrade with and without salt at various temperatures.

FIG. 3 shows apparatus for implementing the process, according to some embodiments of the present invention.

### DETAILED DESCRIPTION OF THE INVENTION

The inventors conducted tests and derived supporting data to confirm the implementation of the process according to the present invention, as forth below:

### Supporting Data

### Test Setup

Tests were conducted using commercial nonionic ethoxylated alcohol-based surfactants. The densities of the surfactants were all close to that of water (e.g., +0.2% to −3.3%). The following test results are based on a soluble Dow surfactant that was upgraded from a low concentrated solution to a higher concentration solution while recovering a significant portion of the surfactant.

### Test Procedure

In this test procedure, a series of low concentration surfactant solutions were formulated using water and a commercial nonionic surfactant. The density of the surfactant was 1.002 g/ml at 20 degrees C, and the initial concentrations of the mixtures ranged from 0.20% to 0.32% surfactant. Sodium chloride (NaCl) was added in a known amount to the solutions (8.0% by weight) to “salt out” or bring the surfactant out of solution. The addition of salt raised the density of the water/salt solution to approximately 1.058. The temperature of each solution was elevated to help promote faster separation and recovery although separation and upgrade occurs at lower temperatures (23 degrees C) as well. For each test, a 12 ml sample was taken and put into a 15 ml tube for centrifugation. The centrifuge used was purchased from Cole Palmer and had a rotational speed of 3400 rpm and generated an average g-force on the solution of about 690 g (i.e., 690 times the force of gravity). The tubes were spun, e.g., for either 30 seconds or 60 seconds depending upon the test. Prior to spinning the tubes, the temperature of the tubes were heated to various temperatures between a range of 45.5 C to 60 C to promote faster separation. In addition to the above tests, tests were conducted on similar low concentration surfactant solutions without the addition of salt for comparative purposes. To obtain higher accuracy in the test data, three centrifuges tubes of solution were run simultaneously for each test and the results combined for each test condition.

After spinning the tubes in the centrifuge, the lower density surfactant (which is no longer soluble due to the salt) aggregates and separates to the top of the tube. A small diameter tube is inserted to the bottom of the centrifuge tube and most of the fluid is extracted using a syringe. A small amount of fluid representing the top portion of the fluid containing the separated surfactant along with some salt water was not extracted. Typically, the remaining fluid was on the order of 0.5 ml, or about 4% of the starting fluid weight. The remaining liquid in the centrifuge tube was weighed and placed into a tray and evaporated at 70 degrees C. The 70 degree C evaporation temperature was selected because it will evaporate any remaining water content and leave the surfactant content unaffected due to its much higher evaporation temperature. The remaining mass after evaporation is again weighed. The difference in the pre to post evaporation weights represents the amount of water that was in the sample of recovered surfactant solution from the top of the centrifuge tube. Knowing the weight of the evaporated water and knowing the starting salt concentration, the remaining salt mass in the evaporated sample can be calculated and subtracted from the evaporated mass. The final number represents the weight of the surfactant that was separated to the top of the centrifuge tube. Knowing the starting weight of the fluid sample in the centrifuge tube, the salt concentration and the starting surfactant concentration, the starting mass of the surfactant in the centrifuge tube can be calculated. The surfactant recovery is calculated by dividing the surfactant mass of the evaporated sample by the starting mass of the surfactant contained in the starting solution prior to centrifugation. The upgrade in concentration can be calculated by dividing the final surfactant concentration in the evaporation sample to the starting concentration.

### Test Results

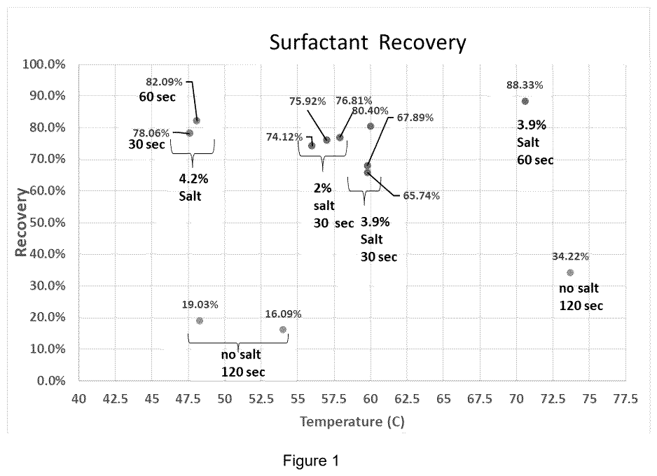

FIG. 1 shows examples of a percent surfactant recovery and of low concentration surfactant solutions with and without the addition of salt at various spin times and temperatures. Note that the spin times for the no-salt tests were increased three to six times longer than the with-salt tests to try to promote better separation.

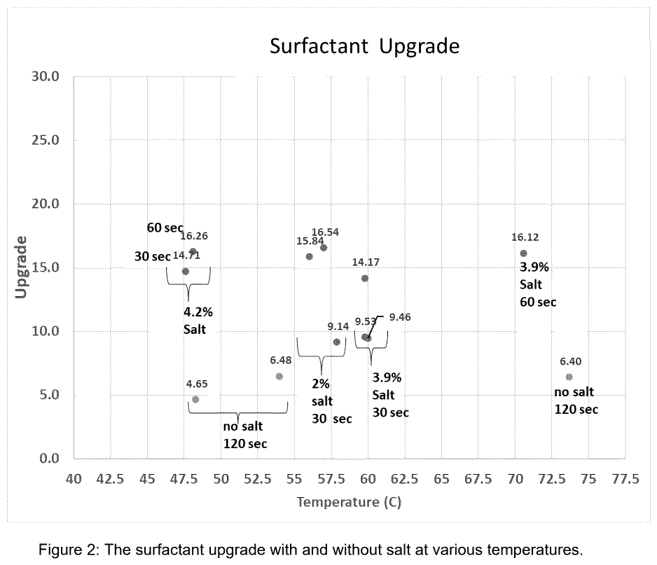

FIG. 2 shows a surfactant upgrade with and without salt at various temperatures. It is noted that the upgrade results are dependent upon the extraction process after centrifugation. The amount of light fluid remaining after extraction was not consistent from test to test because remaining light solution after extraction was approximated by eye. In tests where less solution was extracted, more water would remain in the top part of the sample to be evaporated resulting in a lower upgrade. In tests where more water was extracted, the remaining concentration would be higher in that sample leading to a higher upgrade. Since the main goal of these tests were to obtain high surfactant recoveries, the extraction process was purposely preformed to error in the direction of leaving surplus water in the evaporated solution to guarantee good recoveries at the expense of lower upgrades.

It is also important to note that in a field deployed system, this method could be implemented as a continuous process.

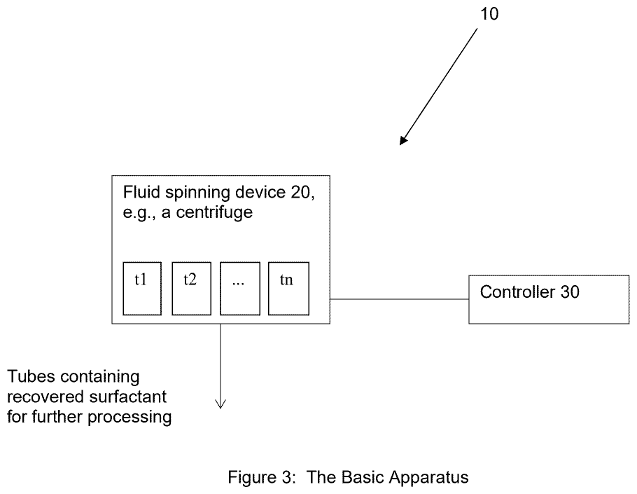

### FIG. 3: Apparatus

By way of example, FIG. 3 shows the present invention in the form of apparatus generally indicated as 10 for implementing the process described herein, as follows:

The apparatus 10 may include, or take the form of, a separation processor, for separating a surfactant from a solvent in a solution, e.g., that features a fluid spinning device 20 and a controller 30.

The fluid spinning device 20 may be configured to
receive one or more tubes t1, t2, . . . , tn, each tube t1, t2, . . . , tn having a top portion and a bottom portion and containing a solution having a solvent and a surfactant, and also having a salt added to the solution,
receive a control signal containing information to spin the fluid spinning device for a predetermined period of time and apply a high g environment that causes a more dense solvent to move downwardly towards the bottom portion of the one or more tubes t1, t2, . . . , tn and a less dense surfactant to move upwardly towards the top portion of the one or more tubes t1, t2, . . . , tn to separate the more dense solvent from the less dense surfactant, and
provide one or more processed tubes, each processed tube having the more dense solvent in the bottom portion and the less dense surfactant in the top portion; and

The controller 30 may be configured to provide the control signal to spin the fluid spinning device for the predetermined period of time and apply the high g environment to separate the more dense solvent from the less dense surfactant. By way of example, the fluid spinning device 20 and the controller 30 may form part of the same unit or component, or the fluid spinning device 20 and the controller 30 may form part of separate units or components.

By way of example, the fluid spinning device 20 may include a centrifuge. Centrifuges are known in the art, and the scope of the invention is not intended to be limited to any particular type or kind thereof either now known or later developed in the future.

The salt may be a chemical salt configured to increase the density of the solution and also increases a difference in the density between the solvent and the surfactant in the solution and lower a cloud point temperature of the solution to promote micelle formation caused by precipitation of the surfactant that promotes aggregation of micelles.

The control signal contains information to spin the fluid spinning device 20 at a predetermined rotational spin to apply the high g environment.

The apparatus 10 may include a thermal heater configured to raise the temperature of the solution in the one or more tubes t1, t2, . . . , tn prior to spinning the fluid spinning device 20 and applying the high g environment. The thermal heater may form part of the fluid spinning device 20 and heat the one or more tubes t1, t2, . . . , tn within the fluid spinning device 20.

The controller 30 may be configured to provide a temperature control signal containing information to heat the one or more tubes t1, t2, . . . , tn to a predetermined temperature; and the thermal heater may be configured to receive the temperature control signal and raise the temperature of the one or more tubes t1, t2, . . . , tn to the predetermined temperature.

By way of example, the controller 20 may respond to either a user ON/OFF input (e.g., ON/OFF button) or signaling from a remote process controller device, and provide the control signal to spin the fluid spinning device for the predetermined period of time at the predetermined rotational spin.

### Applications

The scope of the invention is described in relation to mineral separation, including the separation of copper from ore.

### The Related Family

By way of example, this application is also related to a family of nine PCT applications, which were all concurrently filed on 25 May 2012, as follows:
PCT application no. PCT/US12/39528 (Atty docket no. 712-002.356-1), entitled “Flotation separation using lightweight synthetic bubbles and beads;”
PCT application no. PCT/US12/39524 (Atty docket no. 712-002.359-1), entitled “Mineral separation using functionalized polymer membranes;”
PCT application no. PCT/US12/39540 (Atty docket no. 712-002.359-2), entitled “Mineral separation using sized, weighted and magnetized beads;”
PCT application no. PCT/US12/39576 (Atty docket no. 712-002.382), entitled “Synthetic bubbles/beads functionalized with molecules for attracting or attaching to mineral particles of interest,” which corresponds to U.S. Pat. No. 9,352,335, which discloses solid beads, belts and filters, but not open-network structures;
PCT application serial no. PCT/US12/39591 (712-2.383-1/CCS-0090), entitled “Method and system for releasing mineral from synthetic bubbles and beads,” filed 25 May 2012, which itself claims the benefit of U.S. Provisional Patent Application No. 61/489,893, filed 25 May 2011, and U.S. Provisional Patent Application No. 61/533,544, filed 12 Sep. 2011, which corresponds to co-pending U.S. patent application Ser. No. 14/117,912, filed 15 Nov. 2013;
PCT application no. PCT/US/39596 (Atty docket no. 712-002.384), entitled “Synthetic bubbles and beads having hydrophobic surface;”
PCT application no. PCT/US/39631 (Atty docket no. 712-002.385), entitled “Mineral separation using functionalized filters and membranes,” which corresponds to U.S. Pat. No. 9,302,270;”
PCT application no. PCT/US12/39655 (Atty docket no. 712-002.386), entitled “Mineral recovery in tailings using functionalized polymers;” and
PCT application no. PCT/US12/39658 (Atty docket no. 712-002.387), entitled “Techniques for transporting synthetic beads or bubbles In a flotation cell or column,” all of which are incorporated by reference in their entirety.

This application also related to PCT application no. PCT/US2013/042202 (Atty docket no. 712-002.389-1/CCS-0086), filed 22 May 2013, entitled “Charged engineered polymer beads/bubbles functionalized with molecules for attracting and attaching to mineral particles of interest for flotation separation,” which claims the benefit of U.S. Provisional Patent Application No. 61/650,210, filed 22 May 2012, which is incorporated by reference herein in its entirety.

This application is also related to PCT/US2014/037823, filed 13 May 2014, entitled “Polymer surfaces having a siloxane functional group,” which claims benefit to U.S. Provisional Patent Application No. 61/822,679 (Atty docket no. 712-002.395/CCS-0123), filed 13 May 2013, as well as U.S. patent application Ser. No. 14/118,984 (Atty docket no. 712-002.385/CCS-0092), filed 27 Jan. 2014, and is a continuation-in-part to PCT application no. PCT/US12/39631(712 -002.385/CCS-0092), filed 25 May 2012, which are all hereby incorporated by reference in their entirety.

This application also related to PCT application no. PCT/US13/28303 (Atty docket no. 712-002.377-1/CCS-0081/82), filed 28 Feb. 2013, entitled “Method and system for flotation separation in a magnetically controllable and steerable foam,” which is also hereby incorporated by reference in its entirety.

This application also related to PCT application no. PCT/US16/57334 (Atty docket no. 712-002.424-1/CCS-0151), filed 17 Oct. 2016, entitled “Opportunities for recovery augmentation process as applied to molybdenum production,” which is also hereby incorporated by reference in its entirety.

This application also related to PCT application no. PCT/US16/37322 (Atty docket no. 712-002.425-1/CCS-0152), filed 17 Oct. 2016, entitled “Mineral beneficiation utilizing engineered materials for mineral separation and coarse particle recovery,” which is also hereby incorporated by reference in its entirety.

This application also related to PCT application no. PCT/US16/62242 (Atty docket no. 712-002.426-1/CCS-0154), filed 16 Nov. 2016, entitled “Utilizing engineered media for recovery of minerals in tailings stream at the end of a flotation separation process,” which is also hereby incorporated by reference in its entirety.

This application is related to PCT application serial no. PCT/US16/68843 (Atty docket no. 712-002.427-1/CCS-0157), entitled “Tumbler cell form mineral recovery using engineered media,” filed 28 Dec. 2016, which claims benefit to Provisional Application No. 62/272,026, entitled “Tumbler Cell Design for Mineral Recovery Using Engineered Media”, filed 28 Dec. 2015, which are both incorporated by reference herein in their entirety.

### The Scope of the Invention

It should be further appreciated that any of the features, characteristics, alternatives or modifications described regarding a particular embodiment herein may also be applied, used, or incorporated with any other embodiment described herein. Thus, although the invention has been described and illustrated with respect to exemplary embodiments thereof, the foregoing and various other additions and omissions may be made therein and thereto without departing from the spirit and scope of the present invention.

What is claimed is:

1. A process of separating a surfactant in a liquid solution containing the surfactant and a solvent, comprising:
adding a salt to the liquid solution for providing a denser liquid and forcing soluble surfactant out of solution; and
increasing a mechanical g-force applied to the denser liquid to separate the surfactant in the liquid solution.

2. The process according to claim 1, wherein the process comprises providing the mechanical g-force via centrifugation.

3. The process according to claim 2, wherein the mechanical g-force is about 690 g applied to the denser liquid for 30 to 60 seconds.

4. The process according to claim 1, wherein the salt is sodium chloride.

5. The process according to claim 1, the process further comprises elevating temperature of the denser liquid before increasing said mechanical g-force.

6. The process according to claim 1, wherein the solvent is water and the denser liquid has a density of about 1.05 g/ml or higher.

7. The process according to claim 2, wherein
the denser liquid is contained in one or more tubes for centrifugation; and
said process further comprises extracting the surfactant from a top portion of the denser liquid in the one or more tubes after the centrifugation.

8. The process according to claim 1, wherein the surfactant is a nonionic surfactant.

9. The process according to claim 8, wherein the nonionic surfactant is an ethoxylated alcohol-based surfactant.

10. The process according to claim 1, wherein the salt is a chemical salt.

11. The process according to claim 5, wherein the temperature is elevated to a range of 45.5 to 60 degrees C.

12. The process according to claim 1, where the process further comprises reducing density of the liquid solution or the denser liquid through evaporation.

13. The process according to claim 12, wherein said density reducing is carried out by heating the liquid solution or the denser liquid to 70 degrees C.

14. Apparatus, including a separation processor, for separating a surfactant from a solvent in a solution, comprising:
a fluid spinning device configured to
receive one or more tubes, each tube having a top portion and a bottom portion and containing a solution having a solvent and a surfactant, and also having a salt added to the solution,
receive a control signal containing information to spin the fluid spinning device for a predetermined period of time and apply a high g environment that causes a more dense solvent to move downwardly towards the bottom portion of the one or more tubes and a less dense surfactant to move upwardly towards the top portion of the one or more tubes to separate the more dense solvent from the less dense surfactant, and
provide one or more processed tubes, each processed tube having the more dense solvent in the bottom portion and the less dense surfactant in the top portion; and
a controller configured to provide the control signal to spin the fluid spinning device and apply the high g environment to separate the more dense solvent from the less dense surfactant.

15. Apparatus according to claim 14, wherein the fluid spinning device comprises a centrifuge.

16. Apparatus according to claim 14, wherein the salt is a chemical salt configured to increase the density of the solution and also increases a difference in the density between the solvent and the surfactant in the solution and lower a cloud point temperature of the solution to promote micelle formation caused by precipitation of the surfactant that promotes aggregation of micelles.

17. Apparatus according to claim 14, wherein the apparatus comprises a thermal heater configured to raise the temperature of the solution in the one or more tubes prior to spinning the fluid spinning device for the predetermined period of time and applying the high g environment.

18. Apparatus according to claim 17, wherein the thermal heater forms part of the fluid spinning device and heats the one or more tubes within the fluid spinning device.

19. Apparatus according to claim 17, wherein
the controller is configured to provide a temperature control signal containing information to provide heat with the thermal heater at a predetermined temperature; and
the thermal heater is configured to receive the temperature control signal and raise the temperature to the predetermined temperature.

20. Apparatus according to claim 14, wherein the signal contains information to spin the fluid spinning device at a predetermined rotational spin to apply the high g environment.
